(19) United States
(12) Patent Application Publication
(10) Pub. No.: US 2005/0156703 A1
(43) Pub. Date: Jul. 21, 2005

(54) Magnetic toroid connector

(76) Inventor: Mark Twaalfhoven, Hilversum (NL)

Correspondence Address: BLANK ROME LLP, 600 NEW HAMPSHIRE AVENUE, N.W., WASHINGTON, DC, 20037, US

(21) Appl. No.: 10/759,174

(22) Filed: Jan. 20, 2004

(51) Int. Cl. H01F 27/28

(52) U.S. Cl. 336/229

(57) ABSTRACT

The present invention is directed to a toroid used as an inductor or transformer to filter unwanted noise from electrical connectors and devices. The toroid comprises a metal ring surrounded by a platable and non-platable plastic cast, and a conductive layer deposited onto the platable cast. The toroid is manufactured by first molding the non-platable plastic, having helically patterned grooves, around the metal ring. The platable plastic is then molded into the grooves of the non-platable plastic. A conductive plating is then electrodeposited onto the platable plastic to form a helically patterned winding around the metal ring.

### FIELD OF INVENTION

The present invention is directed towards a plated magnetic toroid used as an inductor or transformer to provide noise filtering in electrical connectors and devices.

### BACKGROUND OF THE INVENTION

Data transmission rates for electronic devices and their connectors have been steadily increasing. This increase has made it important to filter any unwanted noise in data signals. One method of noise filtering is to provide a toroid 1 having an insulated metallic wire 2 wound around a circular metal ring 4, an example of which is shown in FIG. 1.

However, this type of toroid is difficult and expensive to manufacture, particularly, for small size toroids that are necessary in electrical connectors and devices. The small size of the metal ring 4 makes the process of winding the metal wire 2 around the ring 4 slow and expensive.

Therefore, it would be advantageous to provide a toroid that can be incorporated into electrical connectors and devices to filter any unwanted noise. Furthermore, it would be advantageous to provide a method of manufacturing a toroid to simplify its automation, and decrease its manufacturing cost.

### SUMMARY AND OBJECTS OF THE INVENTION

The toroid of the present invention is used as an inductor or transformer to filter unwanted noise from electrical connectors and devices. The toroid is manufactured by providing a metal ring surrounded by a non-platable plastic cast. The non-platable plastic cast includes a helically shaped groove around its circumference, into which a platable plastic material is embedded to form a second cast. A conductive plating is then deposited onto the second cast of platable plastic to form a helically shaped conductive winding around the metal ring.

Therefore, the present invention provides a toroid in which a conductive layer or plating is provided on the metal ring without having to undergo the difficult and expensive process of winding a metal wire. The present method of manufacturing a toroid is easier to automate and therefore, reduces its cost.

### BRIEF DESCRIPTION OF THE DRAWINGS

FIG. 1 shows a perspective view of a prior art toroid having a metal wire wound around a metal ring;

FIG. 2 shows a metal ring of the present invention;

FIG. 3 shows the metal ring with a first non-platable cast thereon;

FIG. 4 shows the metal ring with the first non-platable cast and a second platable cast.

FIG. 5 shows the second platable cast;

FIG. 6 shows a conductive plating deposited onto the second platable cast;

FIG. 7 shows input and output conductors attached to the toroid of the present invention; and

FIG. 8 shows a second embodiment of the invention having a rounded metal ring.

### DETAILED DESCRIPTION OF THE PREFERRED EMBODIMENT

Referring now to the several drawing figures in which identical elements are numbered identically throughout, a description of the preferred embodiment of the present invention will be provided.

A plated magnetic toroid 8 (shown in FIG. 6) of the present invention acts as an inductor or transformer to filter unwanted noise in electrical connectors and devices. The plated magnetic toroid 8 comprises a magnetic metal ring 10 surrounded by a first cast 12 of non-platable material having a helical groove 14 therein, and a second cast 16 of platable material molded into the groove 14. A conductive plating 18 is deposited onto the second cast 16. The first cast 12 and the second cast 16 are made of an electrically insulative material, preferably some type of plastic, to insulate the conductive plating 18 from the underlying metal ring 10. In FIG. 6 only the outer layer of the first cast 12 of non-platable material and the conductive plating 18 are visible.

The magnetic toroid 8 of the present invention operates similarly to the prior art toroid 1 shown in FIG. 1. The conductive plating 18 of the present invention performs the function of the metal wire 2 in the prior art. However, the use of the conductive plating 18, and the method used to apply it to the toroid 8 eliminates the unwieldy and expensive process of having to physically wind the metal wire 2 around a metal ring 4.

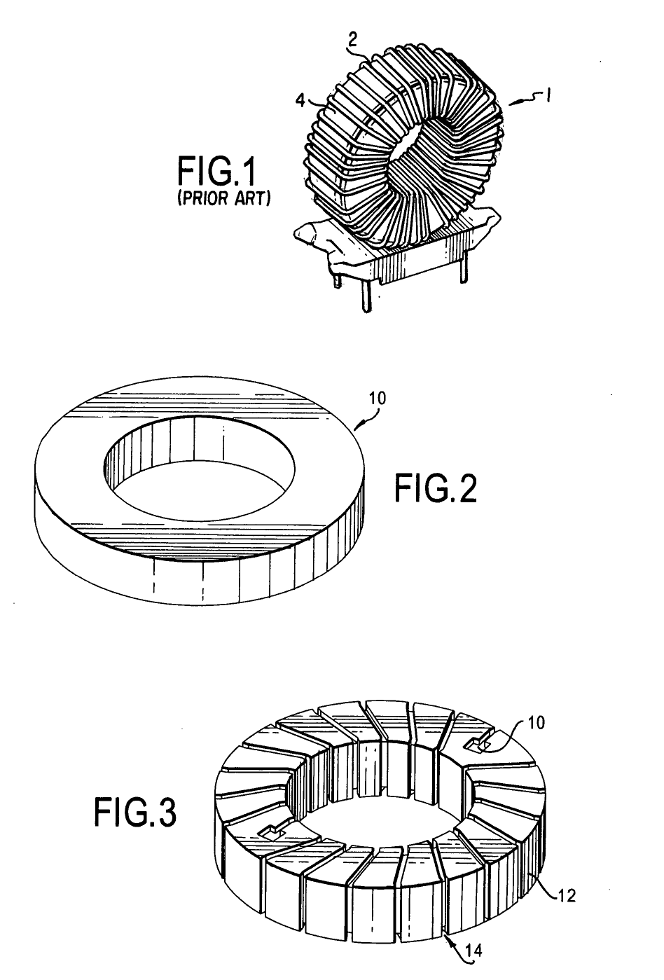

The process of manufacturing the plated magnetic toroid 8 of the present invention is now described. FIG. 2 shows the metal ring 10 of the present invention. The ring is preferably made of ferric oxide, zinc oxide, nickel oxide or copper oxide. FIG. 3 shows the first step of placing a first cast 12 around the circumference of the metal ring 10. The first cast 12 is non-platable material having grooves 14 helically wound around its circumference. The non-platable material is preferably a polycarbonate or polybutylene terephthalate material which prevents the depositing of a conductive plating 18 on its surface. However, it should be understood that the first cast 12 can be made of any electrically insulating material which resists the adhesion of the conductive plating 18. Plastic is the preferred material since it is readily molded into the shape of the first cast 12.

The first cast 12 is formed by placing the metal ring 10 into a first mold (not shown) and injecting the non-platable plastic into the mold. The non-platable plastic is then formed around the metal ring in the desired shape, shown in FIG. 3.

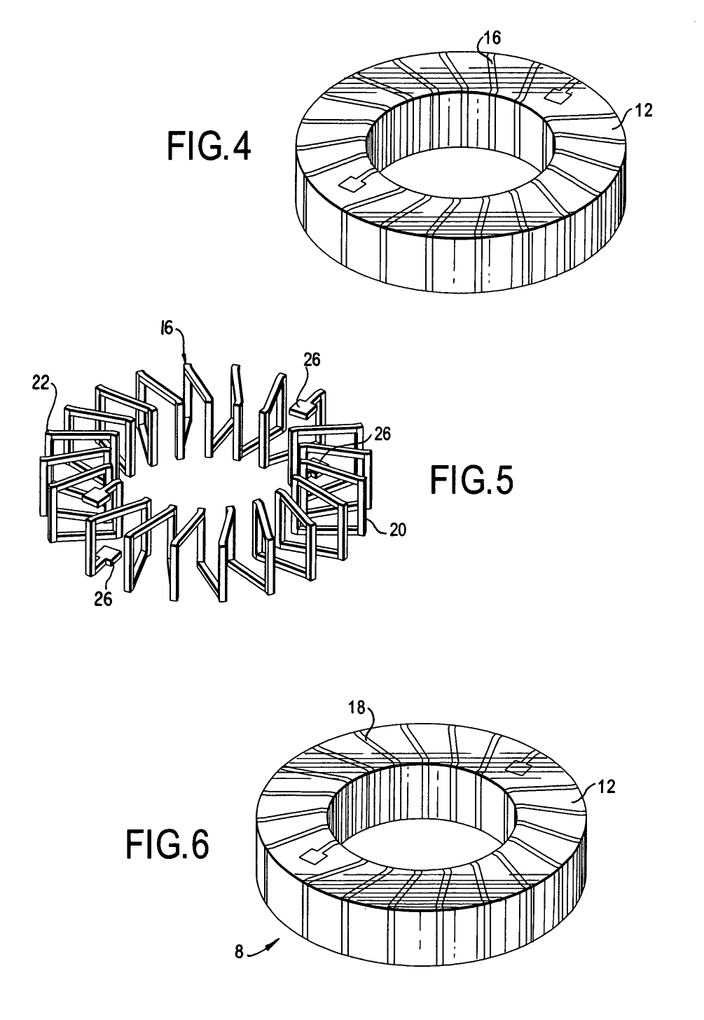

FIG. 4 shows a second step of placing the second cast 16 into the groove 14 of the first cast 12. The second cast 16 is preferably made of a platable plastic material, such as a copolymer of acrylonitrile, butadiene, and styrene (ABS), that allows a conductive plating 18 to be deposited thereon. However, it should be understood that the second cast may be made of any insulating material that promotes the adhesion of the conductive plating 18. It is preferred that the second cast 16 be made of a plastic material because of its electrically insulative properties, and the ease to which it can be molded into the shape of the second cast 16.

The second cast 16 is formed by placing the metal ring 10 and the first cast 12 into a second mold (not shown). The ABS plastic is injected into the second mold so that it fills only the grooves 14 in the first cast 12 to form a helically shaped winding around the metal ring 10. FIG. 5 is an isolated view of the second cast 16, which shows two separate parts 20 and 22, which make up the second cast 16. Each part 20 and 22, include two contact pads 26 on their ends for connection to input and output connectors 28.

FIG. 6 shows a third step of depositing a conductive plating material 18 onto the second cast 16 of platable plastic. The plating material 18 is preferably formed of a three layered copper (Cu)-nickel (Ni)-gold (Au) composite. However, it should be understood that other metals may be used for the conductive plating material 18.

The plating material 18 is deposited onto the second cast 16 by first performing a process known as a chemical strike, where the metal ring 10 surrounded by the first and second casts 12, 16 are bathed in an acidic solution that removes contaminants from its surface and aids the adhesion of the first Cu layer. The first and second casts 12, 16 then undergo a Cu-strike, where they are bathed in a Cu ion solution that electrodeposits a Cu layer onto only the second cast 16 of platable plastic material. A Ni-strike is then performed where the parts are bathed in a Ni ion solution where a Ni layer is electro-deposited onto the Cu layer. Then, a Au-strike process is performed where the parts are bathed in a Au ion solution and a Au layer is electrodeposited onto the surface of the Ni layer.

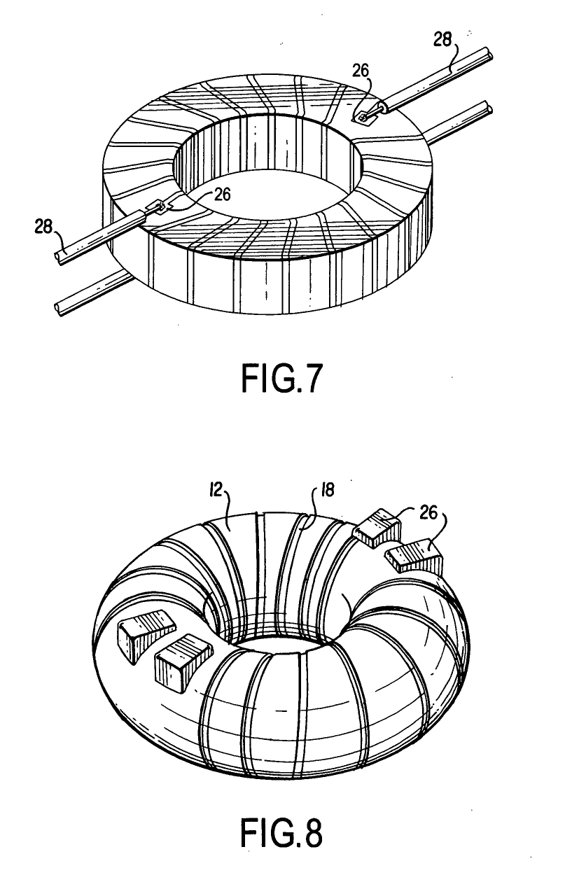

The resultant product is a toroid 8 having a magnetic metal ring 10, surrounded by the insulating first and second casts 12 and 16, and the conductive metal plating 18 helically wound around its circumference. The toroid 8 is then connected to other components via input and output connectors 28 attached to the contact pads 26, as show in FIG. 7.

Furthermore, in certain applications, the toroid must exhibit specific electrical properties to properly perform its noise filtering function. The toroid's electrical properties may be modified by depositing additional layers of conductive plating, using the same process explained above. In this case, an additional non-platable plastic cast (similar to the first cast 12) and a platable plastic cast (similar to the second cast 16) are applied to a toroid already having a Cu—Ni—Au layer, and a second Cu—Ni—Au layer is deposited onto the platable plastic cast using a process similar to that explained above. This process can be repeated until the desired electrical properties are achieved. This is analogous to placing several coils around the metal ring 10 to alter its electrical properties.

FIG. 8 shows another embodiment of the invention where the metal ring is rounded, rather than flat as shown in FIG. 2. The toroid shown in FIG. 8 is identical to the previously described toroid 8 of FIG. 6 in all other respects.

Furthermore, it should be appreciated that many other modifications and variations of the present invention are possible in light of the above teachings, without departing from the spirit or scope of the invention. For example, the preferred materials described above may be modified or changed so long as they individually, and in combination, perform their intended function.

1. A magnetic toroid comprising:
a metal ring surrounded by a first cast made of a non-platable material which resists the adhesion of conductive material, and a second cast made of a platable material that promotes the adhesion of conductive material; and
a conductive material deposited onto the second cast.

2. The magnetic toroid of claim 1, wherein:
the first cast includes grooves on its surface, and the second cast being formed in said grooves.

3. The magnetic toroid of claim 1, wherein:
the first cast and the second cast are made of a plastic material.

4. The magnetic toroid of claim 1, wherein:
the conductive material deposited onto the second cast is a three-layered copper, nickel, gold composite.

5. A method of manufacturing a magnetic toroid comprising the steps of:
providing a metal ring;
molding a first cast around the metal ring;
molding a second cast around the metal ring; and
depositing conductive material onto the second cast.

6. The method of manufacturing a magnetic toroid of claim 5, wherein:
the first cast is made of a non-platable material that resists the adhesion of the conductive material and the second cast is made of a platable material that promotes the adhesion of the conductive materal.

7. The method of manufacturing a magnetic toroid of claim 5, wherein:
the first cast is molded having grooves therein, and the second cast is molded into the grooves.

8. The method of manufacturing a magnetic toroid of claim 5, wherein:
the conductive material is deposited onto the second cast using an electrodepositing technique, where the toroid is bathed in a solution of the conductive material which then adheres to the second cast.

9. The method of manufacturing a magnetic toroid of claim 8, wherein:
the conductive material comprises a three layered copper, nickel, gold composite.

10. The method of manufacturing a magnetic toroid of claim 5, wherein:
multiple layers of conductive material are deposited onto the second cast.

11. The method of manufacturing a magnetic toroid of claim 5, wherein:
prior to depositing on the conductive material onto the second cast, the toroid is cleansed to remove any contaminants thereon.
